(19) United States
(12) Patent Application Publication
(10) Pub. No.: US 2011/0092121 A1
(43) Pub. Date: Apr. 21, 2011

(54) MATERIAL

(76) Inventor: Veronika Kapsali, London (GB)

(21) Appl. No.: 12/919,859

(22) PCT Filed: Feb. 28, 2008
(86) PCT No.: PCT/GB08/00674

§ 371 Date: Dec. 14, 2010

(51) Int. Cl. D03D 15/00; B32B 9/00; B32B 29/00; D04H 13/00; B32B 37/02; B32B 37/12; B32B 38/04

(52) U.S. Cl. 442/181; 428/411.1; 428/532; 442/327; 156/60; 156/148; 156/93; 156/250; 156/256

(57) ABSTRACT

A material has as elements, a plurality of activatable elements each having a portion fixed relative to the material and a portion free to deform relative to the material.

The disclosed invention relates to a material, which, for example, has activatable elements that will deform upon activation.

EP1801274, titled “Woven/Knit fabric including crimped fibre and becoming rugged upon humidification, process for producing the same, and textile product” discloses a crimped filament product that mat be woven or knitted into fabric, which becomes rougher when wetted with water. When dry the crimp decreases. The filament is bi-component, and the two components have differing reactions to the ambient humidity. When wet, the filaments have an increase in crimp, making the surface of the fabric rougher. This changes the properties of the fabric. However, this physical change in the fabric properties has limited applications.

The invention is set out in the claims below. By providing activatable elements having fixed and deformable portions the elements will respond to activations such as a change in humidity by changing shape or deforming—for example curling up when becoming wet, in comparison to the ambient conditions when the material was manufactured. When incorporated into a fabric, the material thus increases permeability for air/heat/moisture to pass through it according to the local humidity. As will be clear from the following description, particular arrangements of the material within a fabric will give the fabric advantageous physical properties that are required for the particular application.

Embodiments of the invention will now be described with reference to the accompanying figures, of which:

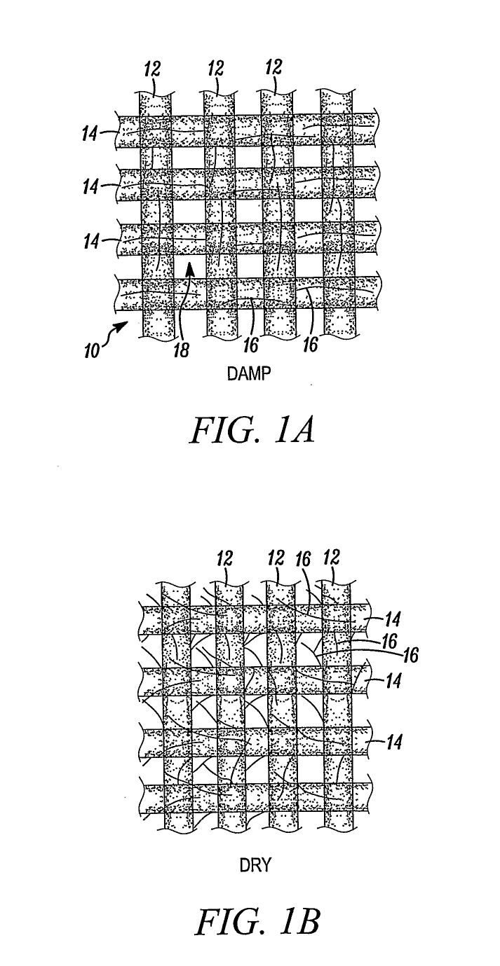

FIG. 1a shows a woven fabric according to the present invention in a damp state;

FIG. 1b shows a woven fabric according to the present invention in a dry state;

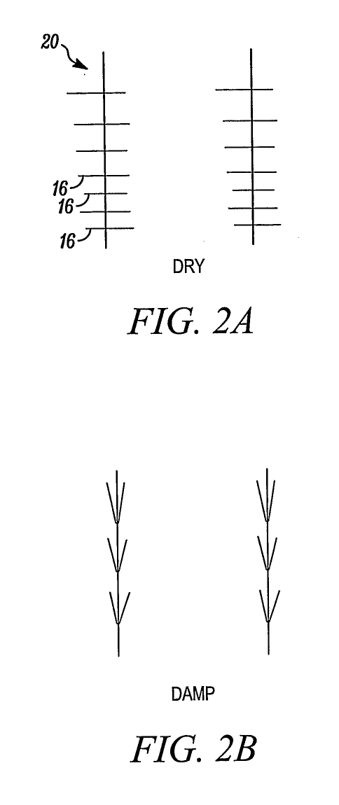

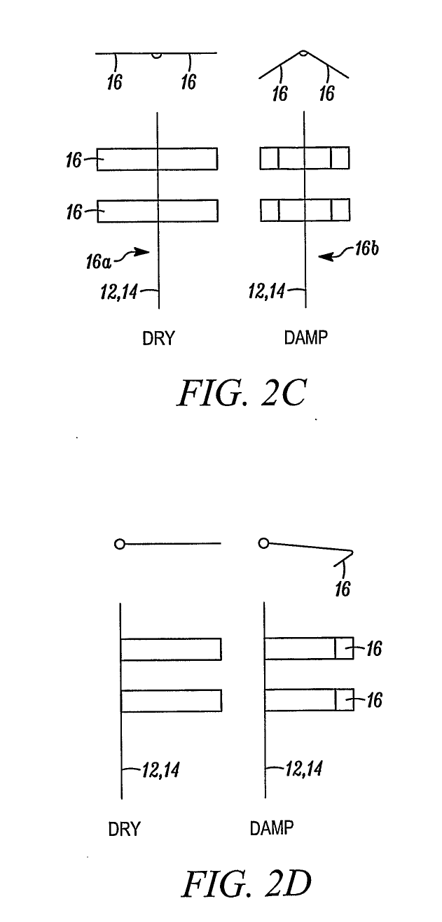

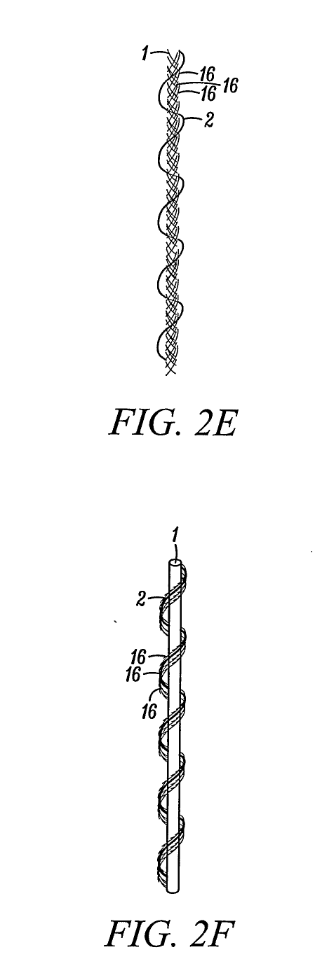

FIG. 2a shows a pair of chenille yarns in a dry state;

FIG. 2b shows a pair of chenille yarns in a damp state;

FIG. 2c shows activatable film elements in a chenille yarn in dry and damp states;

FIG. 2d shows activatable elements in an alternative configuration in dry and damp states;

FIG. 2e shows a first core-spun yarn configuration according to the present invention;

FIG. 2f shows a second core-spun yarn configuration according to the present invention;

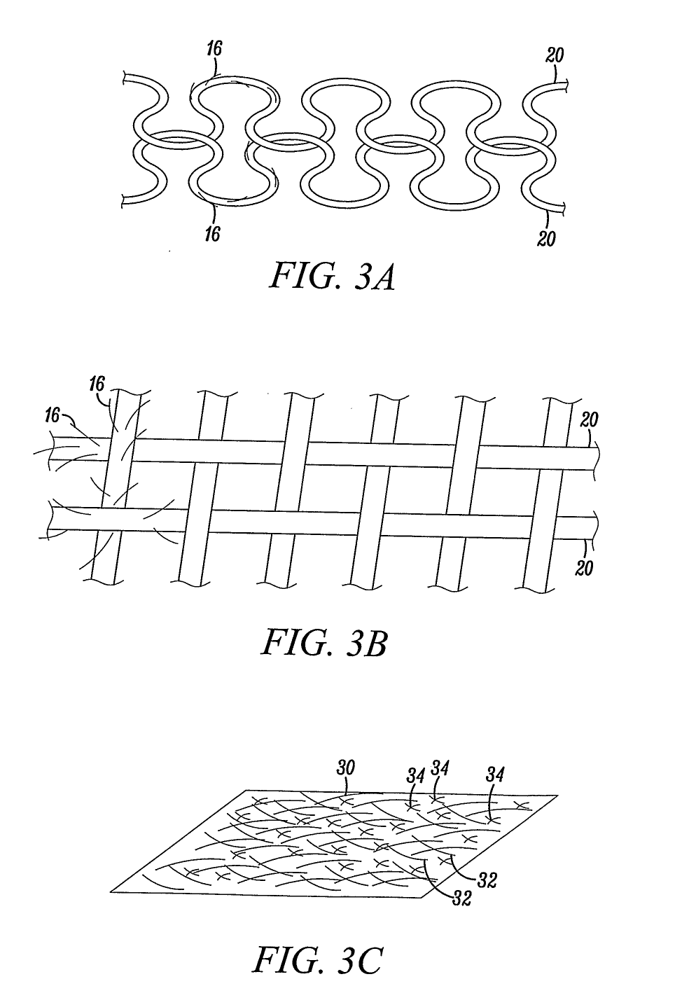

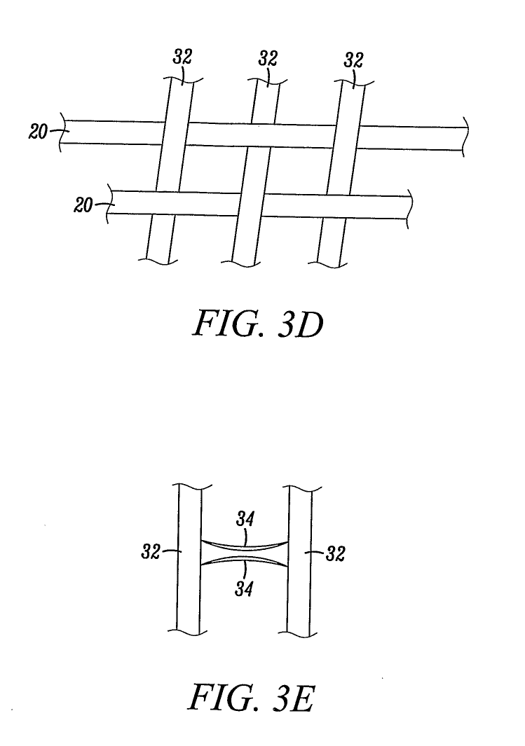

FIG. 3a shows an activatable yarn in a first configuration;

FIG. 3b shows an activatable yarn in a second configuration;

FIG. 3c shows an activatable element in a non woven configuration;

FIG. 3d shows a monofilament in a woven configuration;

FIG. 3e shows the woven monofilaments in a damp state;

FIG. 4 shows various bi-component fibre configurations;

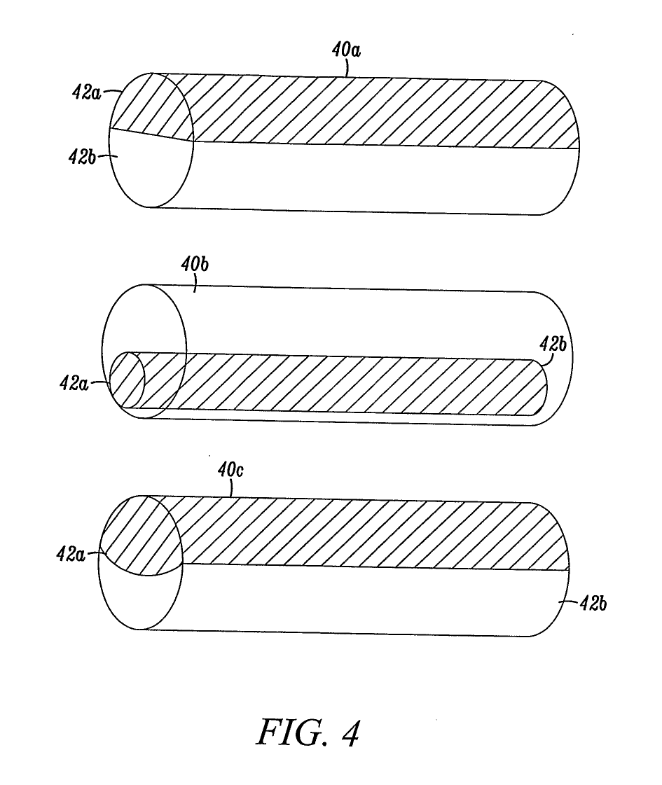

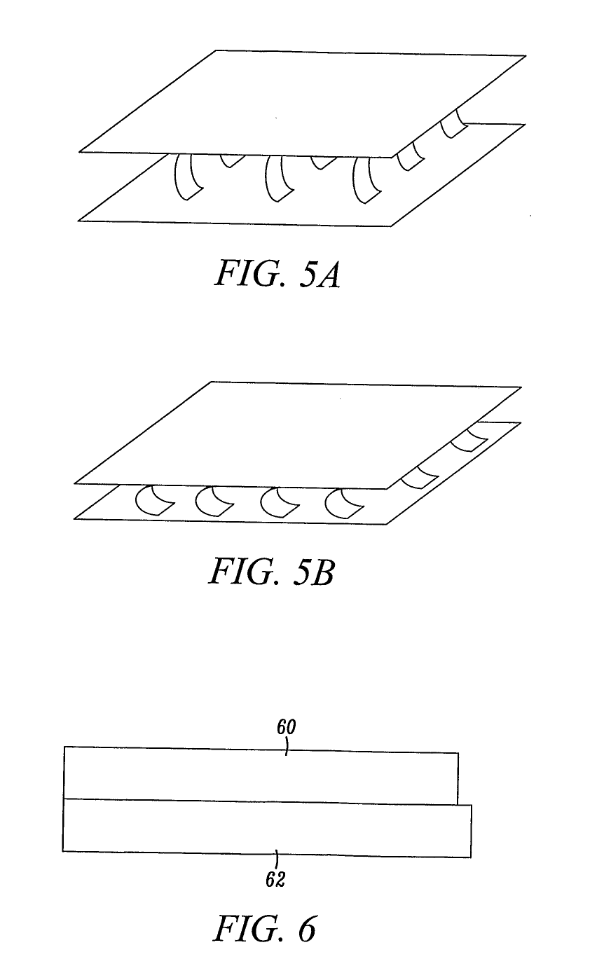

FIG. 5a shows a bi-layer configuration spaced by activatable elements;

FIG. 5b shows the bi-layer arrangement of FIG. 5a in a alternative activation environment; and

FIG. 6 shows a bi-layer film.

Within the textile industry there are many applications where a humidity responsive material would be useful. For example in the modern urban environment people are constantly moving between hot and humid environments to air-conditioned buildings.

With such a lifestyle it is difficult to remain comfortable in all conditions, as different clothes will be suitable for different environments. It is known that people feel particularly uncomfortable when they are hot and sweaty from walking. The level of discomfort is more closely related to a feeling of damp clothing than it is to temperature. The present invention provides a fabric that is breathable when damp, and warm when dry. This is contrary to how most natural fibres react. Natural fibres tend to swell when damp, making them more bulky. This makes them less breathable than when they are dry, as they swell into the spaces between the yarns, making the space smaller and therefore making it more difficult for moisture to pass through the fabric.

In particular the present arrangement provides a material which can, for example, be a component material of a yarn, a yarn itself or a fabric, which has activatable elements for example composed of film/sheets or fibres. The activatable elements have a portion which is fixed relative to the material, for example by being woven, stitched, knitted or otherwise bound into it, and a portion which is free to deform relative to the material. In embodiments, the middle portion of a short length of activatable film is fixed by confinement between two twisted yarns. The free ends of the film element are free to change shape or deform relative to the material/fixed portion upon activation. In particular, the activatable element can have components arranged such that there is a relative difference in change of physical dimension therebetween upon activation.

In the case of a short length of activatable film, this can be formed of two layers one of which expands more when activated by moisture than the other such that, upon activation, the entire element deforms by curving or curling because of the differential change in dimension. When a fabric including multiple such activatable elements is exposed to an activation environment such as a humid environment, therefore, each activatable element decreases in projected cross section creating greater spacing between elements within the fabric and hence reduced resistance to air passing through. This enhanced permeability in turn ensures greater ventilation and hence a cooling effect in the humid environment.

The overall concept of the invention disclosed herein, as described above, is shown in FIG. 1. FIG. 1a shows the concept of a woven fabric (10) when it is damp, and FIG. 1b shows the same woven fabric (10) when dry. The fabric comprise yarns making up the main body of the weave, warp (12) and weft (14). As is known a yarn is typically formed of one or more fibres twisted or otherwise held together. In addition short lengths of film or fibre activatable elements (16) are attached to the yarns such that they do not form supports themselves. When damp, the activatable elements change shape and align with the warp and weft allowing large spaces (18) between the yarns of the weave. This allows moisture and heat to escape that may be trapped by the fabric. In contrast, when the fabric is dry the elements are not aligned with the warp and weft, filling some of the gaps in the weave of the fabric, and therefore trapping moisture and heat and increasing air resistance. This allows the fabric to feel comfortable in both hot humid, and cool dry conditions.

The activatable elements can comprise staple, as is known in the textile art, comprising lengths of fibre or film that can be twisted together to form a yarn or supported on a yarn and may be made by forming a bi-component film or bi-component fibre.

The bi-component staple film comprises two layers (60, 62) of film bonded or otherwise connected together as shown in FIG. 6. Each layer of film has a different reaction to humidity changes. Any known materials having such properties may be used to make such a film. Because each component changes its length by a different amount, the element is forced to curl or deform. Bi-component film may be made from any known method, for example, by film spinning or extruding sheet film with two components, or combining two films together which can be bonded together.

The staple elements can be used to form a chenille yarn. Yarns are typically made when staple elements are twisted or otherwise held together. At their simplest level, single-ply yarns are where there is only one stage of twisting. More commonly, the single-ply yarn is then twisted together with other yarns to make a multi-ply yarn. Multi-ply yarns are thicker and more robust than single-ply yarns. In addition, multi-ply yarns may have a more complicated structure than single-ply yarns, allowing for more complex yarns to be made.

Chenille yarns are made from two single-ply yarns twisted together, and at regular intervals a third yarn or staple element or “pile” is trapped between the two single-ply yarns, normally, although not necessarily, in an orthogonal direction. This is often most simply made using a loom constructing many chenille yarns at once, and the third yarn is inserted using a continuous length while the first two yarns are twisted together. The third yarn is then cut between the first to yarns to make the pile. Thus, the third yarn is supported by the two single-ply yarns and it is possible to control the length of the free ends of the third yarn.

FIG. 2a shows schematic diagrams of staple fibres made into a chenille yarn (20) according to an aspect of the invention comprising two twisted dry yarns. The pile of the chenille yarn is made up of activatable elements (16) as described above and have relatively free ends generally symmetrically disposed about the axis of the yarn. The activatable elements (16) are spaced approximately evenly along the yarn. In this embodiment the activatable elements are supported along the yarn such that when dry the elements are roughly orthogonal to the main axis of the yarn and can be in the plane of the page (FIG. 2c) or perpendicular to the plane of the page in the drawings. This structure gives the yarn a large cross section.

FIG. 2b shows two wet yarns. The activatable elements have reacted to a change of humidity and have changed in profile, curling up, away from the support point, so that they are more closely aligned with the axis of the yarn. Depending on the orientation of the activatable elements they may alternatively curl out of the plane of the page, and of course some elements may be disposed to curl in the opposite direction.

This reduces the cross section of the yarn hence increasing permeability as can also be seen in FIG. 2c in which the dry (16a) and damp (16b) configurations can be seen, and it will be seen that there is now a much wider space between the two yarns. It will be seen that the staple elements can alternatively be fibre as discussed in more detail below.

There are numerous alternative ways that the activatable material may be incorporated into a yarn. FIG. 2d, shows an alternative orientations for activatable elements (16) incorporated into yarns where they are fixed substantively at one end.

Further, the staple elements may be used, for instance, as a component to a core spun yarn, FIG. 2e, which has a similar structure as that used for Lycra™ yarns. In a core spun yarn of known type, the core (1) may be made from staple elements or several monofilaments. Another fibre (2) is then wrapped around the core, binding the staple fibres or monofilaments together.

In embodiments of the invention, the activatable elements (16) may make up either the core (1) (FIG. 2e) or the binding part (2) (FIG. 2f) of the yarn. Where the activatable element (16) makes up the core (1), staple fibres are bound by twisting or any other appropriate manner, for example by loosely spun binding support fibres (2). The surface of the yarn is then brushed to draw out loose ends (16) of the activatable element, so that they have a degree of freedom to react to changes in humidity. The direction of the reaction of the activatable elements may be controlled by the orientation of the staple fibres within the yarn and the direction of the brush finishing treatment. Alternatively, where the activatable elements are used to bind the core (1), any suitable fibre may be used to make up the core. These may be staple or monofilament fibres. The binding part of the yarn (2) may be made totally from activatable elements, or only a portion of activatable elements depending on the properties desired for the finished product. However, it is important that staple fibres are used so that there are a number of free ends when the yarn is finished such that the free portion will deform upon activation to reduce the cross section at the yarn whether in the core, the binding part or both.

The skilled person will understand that a yarn may be constructed in a number of ways that enable the activatable material to be supported and have free ends, and should not be limited to the examples given above.

An alternative to using staple elements formed of a split film, it is also possible to form, for example extrude bi-component fibres 40a, b, c with the desired properties. These may be made from similar materials as the bi-component film.

Bi-component fibres are generally known in the field. FIG. 4 shows various configurations of fibres that may be formed according to the present invention. The two different components 42a, b are shown. As is noted from the figures various cross-sections are possible including segmentation across the diameter (40a), a smaller cylinder within a larger cylinder (40b) or a curved boundary between segments (40c), and are not limited to the configurations shown. In all cases because the components change dimension by a different amount in a change of activation environment, the fibres will deform. It should be understood that the precise cross-section is not important, however asymmetrical distribution, in at least one direction, of the two components across the fibre is advantageous. It is also possible that the cross section of the fibre may vary along the length of the fibre. Yet further one component can be coated on a portion of an elongate length of the other, for example around half of the circumference viewed in cross section.

Once the activatable element of any of the types described above has been made or incorporated into yarns (20), the yarns themselves may be knitted (FIG. 3a) or woven (FIG. 3b) into fabric in a normal way. This may be in conjunction with support elements for example providing the warp or weft, all yarns may be activatable. The precise method of fabric production used may be dependent on the final application for the fabric, and the desired humidity reaction achieved by the change in yarn cross section upon activation. As will be appreciated a yarn, such as that shown in FIG. 2, may be woven with similar yarns and result in a fabric as schematically shown in FIG. 1.

Alternatively, the activatable material may be incorporated into a non-activatable fabric using finishing techniques. By way of an example, activatable material elements may be attached to the surface of a fabric by way of embroidery. In an embroidery process, the material would be placed on the fabric and stitched securely into place. The manufacturer may control the quantity of stitching and the location of the stitching to produce the desired properties of the finished product. Embroidery and other such techniques are known to the person skilled in the art, and have been widely demonstrated in many applications. These include attaching a backing material, such as interfacing, in order to stiffen a portion of a garment, or a large piece of backing material behind a decorative piece of embroidery. The backing material may then be trimmed, however in this case, the trimming will be necessarily different as required for the finished product.

Staple elements may additionally be used without combining with additional fibres or other support elements into yarns or forming into yarns themselves. The staple elements may be formed into non-woven fabrics, (FIG. 3c) with a similar structure to that of felt. Felt is formed from a number of staple elements which are arranged at random in a plane. The elements are held together by a natural crimp which causes the elements to be entangled so much that they are very difficult to pull apart, and thus they form a stable fabric. A similar sort of structure may be seen in fibre-glass where randomly arranged fibres are held together by a matrix that does not have good structural properties, or in non-crystalline polymer plastics.

According to embodiments of the invention, the elements (30) can be attached to themselves or other staple elements in a non-woven manner in the fabric in order to provide support for the fibres leaving free ends (32) which may deform when activated. It is necessary to support the elements to hold them together to form a fabric, but also not provide so much support that the other properties of the fabric, such as flexibility, are lost. This type of support may be provided by “spot-welding” (34) the elements together at regular intervals. It will be appreciated that any suitable method may be used to do this, such as heat, chemical treatments, glue, or stitching the elements together using embroidery finishing techniques. This can be applied both to staple sheets and fibres.

In a further embodiment, monofilament activatable elements may be used to create yarns where the filament is bi-component. This would make it unnecessary to attach activatable elements to the fabric, but instead would rely on deformation of the free portion of the element between points of confinement. For example where in FIG. 3d activable elements in the form of film monofilaments 20 are woven with support elements 32 the activatable elements will curl along their sides as shown in more detail in FIG. 3e at 34, reducing the cross-section in a similar manner to that described above.

According to another embodiment at least one activatable element is provided extending between two layers, the two outer layers being inert and supporting activatable elements located therebetween (FIG. 5a). Upon activation the elements change shape and curl and draw the inert layers together thus reducing the cross-section of the fabric and changing the insulating properties (FIG. 5b). Such a structure would be similar to corrugated cardboard in appearance.

In the above described embodiments the material has been responsive to a change in humidity relative to the ambient humidity when the material was made. Having two components with different humidity behaviour in the same material, means that the material will deform when the humidity characteristics are stronger than the forces holding the material in its “neutral” position. This reaction is not necessarily a change in overall dimension, as it is with natural fibres, however it is a change in configuration that will result. This change in configuration will not change the fibres insulation properties, however, when arranged in a fabric, overall the change in shape of the individual fibres may change the insulation properties of the fabric. It will be noted that as an alternative approach, the elements may be formed with a relaxed in a first set of conditions such that in normal ambient conditions they adopt a different shape and deform to their relaxed state only when the conditions match those of manufacture, providing yet further control over the properties of the material.

One embodiment to produce a film approximately 3 micron thick film was made using 5% ethylcellulose, Aqualon r EC N200, and depositing 16% solution of Ghosenol20 (polyvinyl alcohol) to form the second layer. These layers were formed in at atmosphere at 24° C. and at 45% RH (relative humidity). Alternatively a layer of film of a first component can be coated or added in any other manner on the film of a second component. From the bi-component film suitable elements may be cut, depending on the end use. For example the film may be slit it into strips, typically 0.2-0.8 mm in width, to form monofilaments and these can be cut into lengths of staple sheet elements of, say 0.5 to 2 mm.

Fibre elements can be extruded from similar materials to produce activatable elements. Any other appropriate materials having differential behaviour upon activation may of course be used dependent on the application required.

These elements may then be twisted with other fibres to form yarns in any appropriate known manner or used to make other fabric structures as would be clear to a person skilled in the art using any appropriate technique including knitting, weaving, wrap twisting, air jet twisting, rotor twisting or self twisting.

The applications of the present invention are wide ranging, and should not be limited to the embodiments described herein. Textiles are currently used in many different industries and have a wide range of use. As described above, one use is within the clothing industry, and particularly where the clothing has a specific use, such as sports wear, either for the whole garment or panels under the arms. However such fabrics may also be used in fashion items, in order to maintain the maximum level of comfort when moving between changing environments.

In agriculture textiles, the material may be used to control the humidity atmosphere in a greenhouse growing environment by screening off rooms, or as a membrane within or over the soil to control the moisture reaching the plants. In the building and civil engineering industry membranes including the material can be used to control damp within the building. The textiles can be used in road constructions or as packaging materials. Other industrial applications may include packaging, use in filters where humidity is of importance, and within the transport industry, in aircraft and automotive vehicles. Further the fabric may of use in interior applications such as upholstery. Finally the material could be used in medical applications including wound dressings.

The invention as described is not limited to humidity activation. It should be understood that using suitable materials to make the bi-component film or bi-component fibre that have the appropriate physical properties, the material may be activated by different triggers. Possible triggers include changes in magnetic fields, pH and chemical composition of the environment, light and heat. It is even possible to make a fabric that is activated by more than one trigger by combining two or more bi-component fibres.

1-61. (canceled)

62. A material having, as elements, a plurality of moisture activatable elements each having a portion fixed relative to the material and a portion free to deform relative to the material.

63. A material as claimed in claim 62 in which each activatable element has a first and second component arranged such that there is a relative difference in change of physical dimension therebetween upon activation.

64. A material having, as elements, a plurality of activatable elements each having a portion fixed relative to the material and a portion free to deform relative to the material upon activation, in which each activatable element has a first and second component arranged such that there is a relative difference in change of physical dimension therebetween.

65. A material as claimed in claim 64 having, as elements, one or more support elements supporting a fixed portion of an activatable element, optionally in which one or more support elements comprise an activatable element.

66. A material as claimed in any proceeding claim in which the fixed portion is fixed by at least one of the group of weaving, gluing, sticking, bonding or confinement, optionally in which the activatable element comprises a staple element, and preferably in which the staple element comprises a staple sheet, optionally in which the staple element comprises a staple fibre, and preferably in which the staple fibre has a first and second component arranged such as there is a relevant difference in change of physical dimension therebetween upon activation, and preferably in which the staple fibre comprises a volume extending in an elongate direction, the volume having a first portion extending in the elongate direction comprising the first component and a second portion extending in the elongate direction comprising the second component, optionally in which the staple fibre comprises an elongate volume of the first component and a partial surface coating comprising a second component.

67. A material as claimed in claim 66 in which the staple sheet has a first and second component arranged such that there is a relative difference in change of physical dimension therebetween upon activation, optionally in which the first and second components comprise one of respective layers of the sheet or a sheet layer and film layer thereon.

68. A material as claimed in claim 62 in which a portion of the activatable element between its ends is fixed relative to the material and at least one end portion is free to deform relative to the material,
optionally in which an end portion of the activatable element is fixed relative to the material and an opposing end portion is free to deform relative to the material,
optionally in which the activatable element is fixed at spaced end portions relative to the material and a central portion is free to deform relative to the material,
optionally in which each activatable element has a portion fixed on a filament core relative to the material,
optionally in which activatable elements form a filament core around which a filament is wound,
optionally in which the activatable element comprises a monofilament element, and
preferably in which the monofilament element comprises a sheet element, preferably in which the monofilament is knitted, woven, glued, stitched, bonded or confined with a support element,
preferably in which spaced portions of the monofilament element are fixed relative to the support element and a portion intermediate the spaced portions is free to deform relative to the material,
preferably in which the support element comprises an activatable element, preferably in which the monofilament element comprises one of a sheet or fibre elements.

69. A material as claimed in claim 62 in which one or more activatable elements extend between support layers and have a fixed portion at each support layer and a portion free to deform intermediate the support layers,
optionally in which the activatable element is activatable by heat or light,
optionally in which the activatable element is made of first and second cellulose materials comprising first and second components arranged such that there is a relative difference in change of physical dimensions therebetween upon activation.

70. A yarn comprising a material as claimed in claim 62.

71. An activatable fabric formed from the material as claimed in claim 62 wherein the activatable fabric is composed of knitted, woven, glued, stitched, bonded, confined or non-woven elements of material or yarn, and preferably wherein the activatable fabric is arranged to increase permeability upon activation, and preferably wherein a garment is formed of the fabric, optionally wherein the fabric is agricultural textile, a building textile, a geo-textile, a domestic or industrial interior textile, an industrial textile, optionally a filter formed of an industrial textile, a medical textile, optionally a medical dressing formed of a medical textile, a vehicle interior or exterior textile, or a packaging material

72. A method of making an activatable element for a material comprising combining first and second elongate components which have a relative difference in change of physical dimension therebetween upon activation.

73. A method as claimed in claim 72 in which the activatable elements comprises a bi-layer film having layers of respective components or a film of a first component coated with a second component, optionally further comprising cutting the film into elongate strips, and preferably further comprising knitting, weaving, gluing, stitching, bonding or confining the activatable elements with support elements, and preferably in which the support elements further comprise activatable elements, optionally further comprising cutting each elongate strip into a staple element, and preferably further comprising weaving, gluing, stitching, bonding or confining each activatable element relative to a support element, preferably in which each staple element is fixed between its ends, at one end, or at opposed ends on a support element and has a portion free to deform relative to the support element, optionally in which the support element comprises an activatable element, optionally in which the staple elements are spun on or form a filament core, optionally in which the activatable element comprises a fibre, and preferably further comprising knitting, weaving, gluing, stitching or confining the activatable element relative to a support element, optionally further comprising fixing spaced portions of an activatable element relative to respective first and second support layers.

74. A method of activating an activatable material comprising exposing it to an activation environment to cause deformation of an activatable element, optionally in which the activation environment comprises a humid environment.

75. A material having, as elements, a plurality of activatable elements each having a portion fixed relative to the material and a free portion, the element being arranged to change shape upon activation by movement of the free portion, optionally in which the activatable element is arranged to change shape upon activation by deforming from a relaxed to a non-relaxed shape or vice versa.
